(19) United States
(12) Patent Application Publication
(10) Pub. No.: US 2016/0243427 A1
(43) Pub. Date: Aug. 25, 2016

(54) TWO CARD POKER

(71) Applicant: AGS, LLC, Las Vegas, NV (US)

(72) Inventors: Ofir Ventura, Las Vegas, NV (US); John Hemberger, Las Vegas, NV (US)

(21) Appl. No.: 14/673,094

(22) Filed: Mar. 30, 2015

Related U.S. Application Data
(63) Continuation-in-part of application No. 14/628,942, filed on Feb. 23, 2015.

(51) Int. Cl. A63F 1/00; G07F 17/32; A63F 3/00

(52) U.S. Cl. CPC A63F 1/00; A63F 3/00157; G07F 17/3293; A63F 2003/00167; A63F 2001/005

(57) ABSTRACT

A method of playing a poker type and a gaming machine. In the game after a base wager is made, three cards are dealt to a player and a dealer. The player forms a two card hand from the three cards dealt to the player, and the dealer forms a two card hand from the three cards dealt to the dealer. The player then either folds or makes a call wager. If the dealer's two card hand is not a qualifying hand, the call wager is declared a push, and the player is paid even money on the ante wager if the player's hand is ranked higher than the dealer's. If the dealer's two card hand is a qualifying hand, then the player's ante wager and call wager are paid even money if the player's two-card hand outranks the dealer's two-card hand.

### RELATED APPLICATION DATA

This application is a continuation-in-part of U.S. application Ser. No. 14/628,942, filed Feb. 23, 2015.

### BACKGROUND

The disclosed embodiments relate to methods of playing a wagering game and gaming devices. More specifically, the disclosed embodiments relate to methods of playing a two card poker game and a gaming device for playing a two card poker game.

Wagering games such as blackjack, poker, and the like are popular forms of entertainment for many people. Players enjoy playing such traditional casino games, but also are constantly looking for new games or modifications to traditional games to increase excitement during gaming.

Similarly, casinos and other gaming establishments are constantly seeking new types of games to attract players to their properties. It is important for casinos that these new games be easy for players to understand and also allow game play to move along at a rate so many people can participate.

### SUMMARY

The disclosed embodiments have been developed in light of the above and aspects of the invention may include methods of playing and presenting a game, and machines, systems and/or devices for presenting a game.

In one embodiment a game of the invention is presented as a wagering game. In one embodiment, after a player places an ante or base wager to play the game, three cards are dealt to a player and a dealer. The player forms a two card hand from the three cards dealt to the player, and the dealer forms a two card hand from the three cards dealt to the dealer. The player then either folds or makes a call wager. If the dealer's two card hand is not a qualifying hand, the call wager is declared a push, and the player is paid even money on the ante wager if the player's hand is ranked higher than the dealer's. If the dealer's two card hand is a qualifying hand, then the player's ante wager and call wager are paid even money if the player's two-card hand outranks the dealer's two-card hand.

In other embodiments, before dealing the three player cards and the three dealer cards, a player may make an optional bonus wager. The optional bonus wager may be based on the player's two card poker hand being a winning two card poker hand according to a predetermined pay table.

In some embodiments, the predetermined pay table pays out 20 to 1 for a Pair of red Aces, 15 to 1 for a Pair of black Aces, 10 to 1 for a Pair of Aces, 5 to 1 for a Pair of Kings, 4 to 1 for a Pair of Queens, 3 to 1 for a Pair of Jacks, 1 to 1 for a Pair of Sixes through Tens, and a push for a Pair of Twos through Fives. In one embodiment, the player may only win the optional bonus wager if the player also wins the call wager.

In other embodiments, the two card poker hands are ranked in the following order from highest to lowest: Pairs with a Pair of Aces being highest; Straight Flushes with an Ace-King Straight Flush being highest, Flushes with an Ace-Queen Flush being highest, and High Card, with an Ace being highest. In such an embodiment, a two card hand comprising a Straight with no Flush has no value in rank.

In some embodiments, the ante wager and the call wager are paid at 1:1 odds.

In another embodiment, before dealing the three player cards and the three dealer cards, a play may make an optional four card bonus wager. The optional four card bonus wager may be based on whether the player's two card hand and the dealer's two card hand together form a predetermined winning hand, according to a predetermined four card bonus pay table.

The optional four card bonus wager may be paid out for at least one of the following four card hands: Four Aces, Four of a Kind, Four Card Straight Flush, Two Pair, Three of a Kind, Four Card Straight, and Four Card Flush.

Other embodiments of the invention comprise gaming tables, gaming machines, gaming systems or other devices or apparatus for presenting a game. In one preferred embodiment of the invention, the game is played using physical playing cards, such as cards which are dealt at a gaming table.

Further objects, features, and advantages of the present invention over the prior art will become apparent from the detailed description of the drawings which follows, when considered with the attached figures.

### BRIEF DESCRIPTION OF THE DRAWINGS

FIG. 1 is a flow chart illustrating a method of playing two card poker, according to an exemplary embodiment.

FIG. 2 is an example of a gaming table, according to an exemplary embodiment.

FIG. 3 is an example of a gaming machine, according to an exemplary embodiment.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

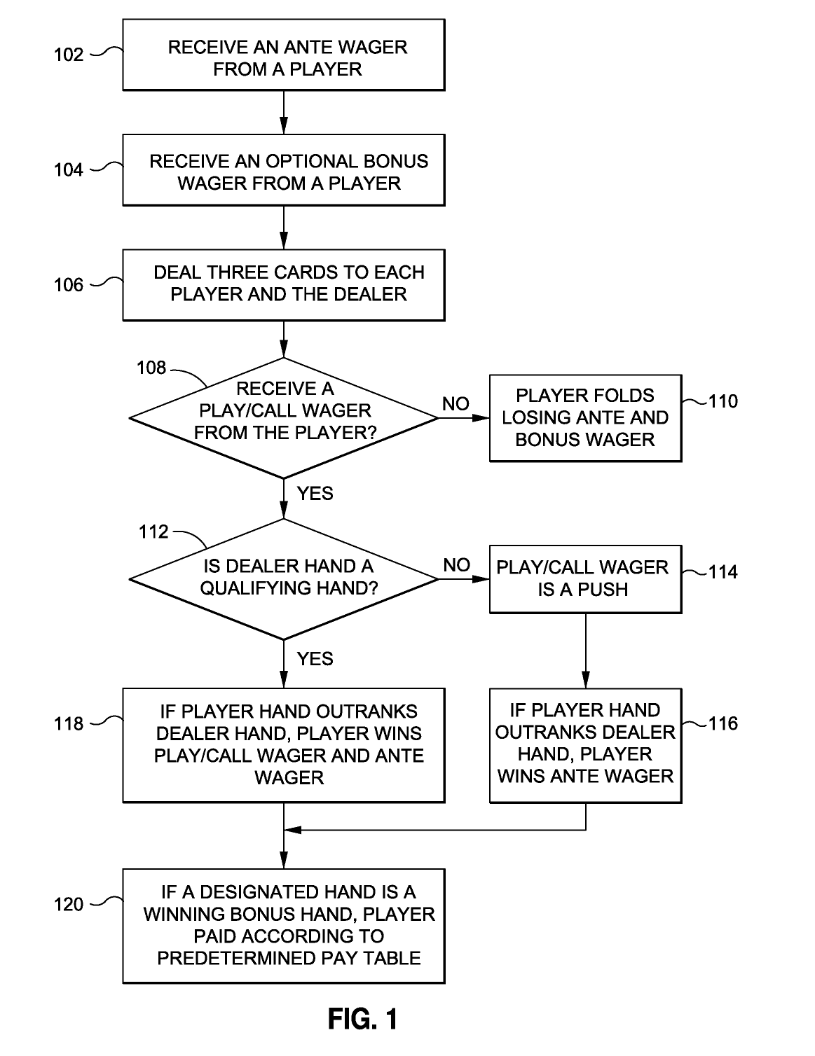

As shown in FIG. 1, one embodiment of the invention is a method of playing a two card poker game. Preferably, the game is played as a wager-based game in which players place bets of money or monetary value equivalent (chips, credits, points, etc.). Thus, in one embodiment, the game begins by each player desiring to participate in the game placing an ante or base wager, as specified in step 102. The size of the ante or base wager may vary and may be a required minimum.

Optionally, a player can also make one or more additional wagers. In a preferred embodiment, a player can make a bonus wager as set forth in step 104. The bonus wager will be described in more detail below. The size of the bonus wager may vary, and may be a required minimum.

In one embodiment, the game may be played using a standard 52 card deck of playing cards (the cards having ranks or values Ace, King, Queen, Jack, 10, 9, 8, 7, 6, 5, 4, 3, and 2 in each of the four suits Hearts, Diamonds, Clubs and Spades, wherein the suits Hearts and Diamonds are the “red” suits, and Clubs and Spades are the “black” suits). In other embodiments, multiple decks of cards or other combinations of cards (modified decks, such as including wild cards/Jokers, etc.) may be used, or other types of cards might be used (including those utilizing other designated suits, etc.). In a step S106, three cards are dealt to each player and to the house or dealer. In the case where the game is presented in a table format, physical cards may be dealt. In the case where the game is presented at a gaming machine or a system including gaming devices, the cards may be dealt electronically, such as by displaying graphical images of cards.

The three cards dealt to each player and the three cards dealt to the dealer are used by each player and the dealer to form two card poker hands. Each player and the dealer thus examines their cards (the dealer hand might be determined electronically such as by a processor evaluating the dealer's three cards) to determine the best two card poker hand that can be formed from the three cards.

Various rankings or criteria may be defined for the two card poker hands. In one embodiment, the Two card poker hands may be ranked highest to lowest as follows:
Pair (e.g. two cards of the same rank, with pairs ranked according to the highest card rank, where the cards are ranked from highest to lowest: A, K, Q, J, 10, 9, 8, 7, 6, 5, 4, 3, 2)
Straight Flush (e.g. two cards having the same suit and having adjacent ranks, where an Ace-King flush is high).
Flush (e.g. two cards having the same suit but not having adjacent ranks, where an Ace-Queen hand is high).
High card (e.g. the highest ranked card).

In order to continue the game, a player may be required to make a call wager. For example, once the player has determined his or her best two card poker hand, the player may make a play or call wager to continue playing the game, as in step 108. Alternatively, the player can decide to fold, as in step 110. When a player folds, the player preferably surrenders his or her ante or base wager and bonus wager (if made) and no longer participates in the game. Players who make a play or call wager may discard the two unused cards of their hands and proceed with their best two card poker hand. In other embodiments, the game could be played without requiring the player to place a call wager.

In step 112, it is first determined if the dealer has a qualified hand. If the dealer does not have a qualified hand, the method proceeds to step 114. In one embodiment, the qualified dealer hand is a two card poker hand meeting a minimum value or criteria, such as a Flush including a minimum of one Jack, or a Flush composed of a Jack and a Two. In step 114 when the dealer's hand does not qualify, the play or call wager receives no action and is declared a push. The play or call wager is thus returned to the player.

In step 116, the player's hand is compared with the dealer's hand to determine which hand has a higher rank. If the dealer's non-qualifying hand is ranked higher than the player's hand then the player loses his or her ante or base wager. However, if the player's hand outranks the dealer's non-qualifying hand, then the player wins his or her ante or base wager. In that event, the player is preferably paid winnings or an award. In an embodiment where the player placed a monetary value wager (or monetary value equivalent wager), the ante or base wager is paid at even money, or at 1:1 odds. If the player's hand and the dealer's hand have the same rank, the wager may be a push (the player's wager is returned), or in other cases the dealer or player could be declared the winner (and if the player is declared the winner, winnings might be awarded).

On the other hand, if the dealer's hand is a qualifying hand, then the method of playing the game proceeds to step 118. Here, the player's hand is compared to the dealer's hand to determine whether the player's hand outranks the dealer's hand. In one embodiment, if the player's hand does not outrank the dealer's hand, then the player loses both the ante wager and call wager. If the player's hand outranks the dealer's hand, then the player is preferably paid an award, such as even money, or 1:1 odds, on both the ante wager and play or call wager.

Lastly, in step 120, regardless of the result of any comparison of the player's hand to the dealer's hand, if the player has made side or bonus wager (and so long as the player made a call wager, if one is required) and the player's hand is one of the ranked hands on a bonus payout table, the player's hand is preferably declared winning and the player is awarded winnings. In one embodiment, the winnings are paid in accordance with a bonus payout table as follows:

TABLE 1
TWO CARD BONUS BET PAY TABLE

| Winning Hand | Pays |
|---|---|
| Red Aces | 20 to 1 |
| Black Aces | 15 to 1 |
| Aces | 10 to 1 |
| Kings | 5 to 1 |
| Queens | 4 to 1 |
| Jacks | 3 to 1 |
| Pair of 6′s-10′s | 1 to 1 |
| Pair of 2′s-5′s | Push |

The present invention offers a fast moving, easy to play game which is exciting. The game is easy to play in that only three cards are dealt to the player and the player need only form a simple 2 card hand using a very basic ranking structure. Further, multiple wagering opportunities may be provided, increasing the excitement of the game. These wagers may include an ante wager, a call wager and a bonus wager. The game offers multiple potential winning opportunities, including resulting from a comparison of the player's hand to the dealer's hand and based upon a comparison to a paytable (e.g. independent of the dealer's hand).

The game may be played by a single player against a dealer/house (or multiple players against the dealer/house). In other embodiments, the game may be played between two or more players (such as where one player acts as a dealer or the house).

The manner in which cards are dealt, order of wagering, etc. may vary. For example, in one embodiment cards may be dealt one at a time, round robin to each player (starting to from the player position to the left of the dealer and proceeding clockwise back to the dealer). Wagering may occur in the same order. However, other configurations are possible.

Other embodiments of the invention are contemplated. For example, in one embodiment, there may be an additional bonus wager available for a four card bonus bet. This allows a player to make an additional four card bet such as prior to start of the game. The four card bonus bet may be placed on a “four card hand” comprising the two player cards that are used from the four cards the player receives and the two dealer cards from the four cards that the dealer receives.

For example, if a player receives the cards 8 [symbol] , 8 [symbol] , 2♡, and 4♦, the player will discard the 2♡ and 4♦ to be left with the 8 [symbol] and 8 [symbol] . If the dealer receives A♦, K [symbol] , 8♦, 8♡, the dealer will discard the A♦ and K [symbol] to be left with the 8♦, 8♡. In this scenario, the four card optional bonus bet is made that the player's two card hand and the dealer's two card hand would be winning (in this case, a Four of a kind: 8 [symbol] , 8 [symbol] , 8♦, and 8♡).

A pay table for the optional four card bonus bet may comprise payouts for Four Aces, Four of a Kind, Four Card Straight Flush, Two Pair, Three of a Kind, Four Card Straight, and Four Card Flush.

It will be appreciated that card or hand rankings may depend upon the cards used in the play of the game, such as if wildcards or special cards are used. Further, other combinations of two cards or four cards might be declared winning or losing.

It will be appreciated that aspects of the invention may be used in other combinations or with other features. As one example, the game might be played with an ante and bonus wager, but no call wager, and wherein the player's two card hand is simply compared to the dealer's two card hand (relative to the ante wager) and the players two card hand is evaluated for a bonus win relative to the bonus wager.

The method of playing the game of the invention may vary depending upon regulatory requirements or the game setting. For example, the above-described method of game play might be implemented in jurisdictions which permit Class III gaming (as such is known under the U.S. Indian Gaming Regulatory Act). However, the game might be presented in other fashions, such as to implement the game as a Class II game (as such as known under the U.S. Indian Gaming Regulatory Act). In one such variation, there is no dealer, but rather a designated player that banks the game. Here, a four card bonus bet option is preferably not independent of the main bet, and the player must win the main hand in order for the first bonus bet to win. That is, the player's hand must outrank the designated player's qualified hand before the player may be paid winnings on the bonus wager.

In one embodiment, a gaming establishment may impose a house rake. The house rake may be imposed upon all players uniformly, upon all players uniformly except for the designated player, or upon the designated player only and not upon any other player. The house rake rules are clearly disclosed at a table for playing the two card poker game.

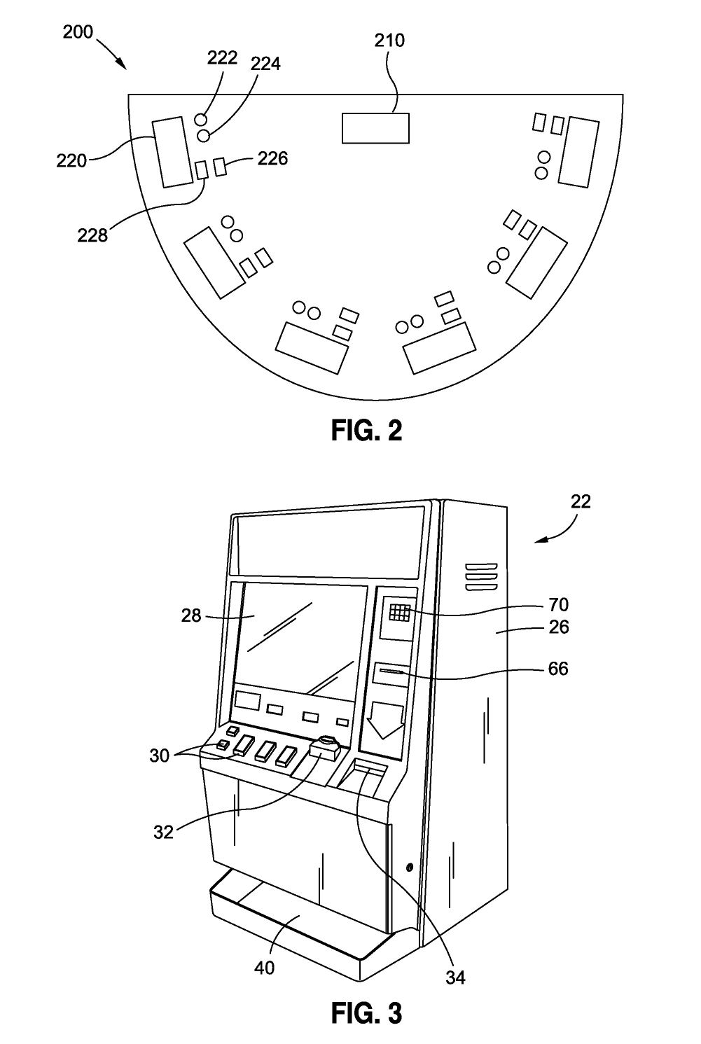

The game of the invention may be implemented in various manners or environments. The game is particularly suited to presentation as a “table” game in which physical cards are dealt. FIG. 2 is an example of a gaming table, according to an exemplary embodiment. In FIG. 2, a gaming table 200 includes a playing surface that defines a dealer or designated player station 210 and a plurality of player stations 220. The player surface may be any suitable surface such as one covered in a felt material or the like.

The player stations 220 each include wagering areas to allow a player to make one or more wagers. For example, the player stations 220 may include an ante wager location 22, and call wager location 224, a bonus wager location 226, and a four card bonus wager location 228. Thus during the play of the game, the player may indicate wagers made to facilitate smooth play of the game. Each player might utilize chips, tokens or the like to place wagers, or wagers might be placed electronically. Cards may be dealt from one or more decks of cards, including from a “shoe” of cards, which shoe may include a shuffling mechanism or the like.

It will be appreciated the gaming table might have other configuration, such as including other features (RFID chip tracking, electronic card identification, player tracking, etc.), as is well known in the art.

The game of the invention might also be presented at one or more gaming machines or devices. FIG. 3 is an example of a gaming machine according to an exemplary embodiment. In one embodiment, the methods of game play and presentation are implemented via a gaming machine or device. Such a gaming machine may have various configurations.

The gaming machine may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

One configuration of a gaming machine 22 is illustrated in FIG. 1. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes. The gaming machine 22 might also include other types of game information display devices, such as one or more spinning mechanical reels, wheels or the like.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28 (such as information comprising generating hands for Two card poker, as detailed above), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 22 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 22 may be configured to detect a wager, such as a signal from a player's depressing of the “bet one” button. Upon such an event and/or the player otherwise signaling the gaming machine to present the game, the controller may be configured to cause cards or other game information to be displayed on the at least one display 28. The controller may accept input from a player of game inputs, such as a request to identify cards to use in a hand, make a call bet or bonus bet, or the like, via the one or more player input devices of the gaming machine 22.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. Thus, the gaming machines 22 is preferably configured to accept value, such as in the form of coins, tokens, paper currency or other elements or devices representing value such as monetary funds. For example, as illustrated in FIG. 3, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

A casino may have numerous such gaming machines 22, such as located on a casino floor or in other locations. Of course, such gaming machines 22 might be used in other environments, such as an airport, a bar or tavern or other locations.

In one embodiment, a gaming machine (and/or associate server, etc.) may be configured to generate and present to the player cards (such as by graphically representing three cards on a video display of the machine), from which the player forms a two card poker hand (such as by “holding” two of the cards). The player's hand may be compared to a generated dealer hand, etc., in the fashion described above. In this embodiment, a single player might play the game of the invention at gaming machine (without a true dealer or second player acting as a dealer).

In another embodiment, the gaming machines might serve as kiosks or presentation devices, including relative to activity generated at a central server or even a gaming table. As one example, physical cards might be dealt at a gaming table and images of those cards might be presented to players via a gaming machine (thus allowing players to participate in the game without being physically present at the table).

It will be understood that the above described arrangements of apparatus and the method there from are merely illustrative of applications of the principles of this invention and many other embodiments and modifications may be made without departing from the spirit and scope of the invention as defined in the claims.

1. A method of playing a poker type game with at least one deck of physical playing cards on a gaming table, the method comprising:
receiving an ante wager from a player at an ante wager location defined at the gaming table;
from the at least one physical deck of playing cards, dealing three cards to the player at a player station defined at the table and dealing three cards to a dealer at a dealer station defined at the table, the player forming a two card hand comprising two cards selected from the three cards dealt to the player, and the dealer forming a two card hand comprising two cards selected from the three cards dealt to the dealer;
receiving an optional call wager from the player at a call wager location defined at the gaming table;
determining whether the dealer's two card hand is a qualified hand according to a predetermined qualification ranking;
when no call wager is received from the player, ending the game with the player folding and forfeiting the ante wager;
when the call wager is received from the player and the dealer's two card hand is not a qualified hand,
declaring the call wager a push and returning the call wager to the player,
comparing the player's two card hand to the dealer's two card hand and paying out the ante wager when the player's two card hand outranks the dealer's two card hand, and collecting the ante wager when the dealer's two card hand outranks the player's two card hand; and
when the call wager is received from the player and the dealer's two card hand is a qualified hand, comparing the player's two card hand to the dealer's two card hand and paying out the ante wager and the call wager when the player's two card hand outranks the dealer's two card hand, and collecting the ante wager and the call wager when the dealer's two card hand outranks the player's two card hand.

2. The method according to claim 1, further comprising:
before dealing the three player cards and the three dealer cards, receiving an optional bonus wager from the player at a bonus wager location defined at the gaming table, the optional bonus wager being based on the player's two card poker hand being a winning two card poker hand according to a predetermined pay table.

3. The method according to claim 2, wherein the predetermined pay table pays out
20 to 1 for a pair of red Aces,
15 to 1 for a pair of black Aces,
10 to 1 for a pair of Aces,
5 to 1 for a pair of Kings,
4 to 1 for a pair of Queens,
3 to 1 for a pair of Jacks,
1 to 1 for a pair of Sixes through Tens, and
a push for a pair of Twos through Fives.

4. The method according to claim 2, wherein the player may only win the optional bonus wager if the player also wins the call wager.

5. The method according to claim 1, wherein
two card poker hands are ranked in the following order from highest to lowest:
pairs with a pair of Aces being highest,
straight flushes with an Ace-King straight flush being highest,
flushes with an Ace-Queen flush being highest, and
high card, with an Ace being highest; and
a two card hand with a straight with no flush has no value in rank.

6. The method according to claim 1, wherein the ante wager and the call wager are paid at 1:1 odds.

7. The method according to claim 1, further comprising:
before dealing the three player cards and the three dealer cards, receiving an optional four card bonus wager from the player, the optional four card bonus wager being based on whether the player's two card hand and the dealer's two card hand together form a predetermined winning hand, according to a predetermined four card bonus pay table.

8. The method according to claim 7, wherein the optional four card bonus wager is paid out for at least one of the following four card hands:
four Aces,
four of a kind,
four card straight flush,
two pair,
three of a kind,
four card straight, and
four card Flush.

9. A gaming machine comprising:
a housing, at least one display, a plurality of input and output devices including a wager accepting device configured to receive a physical item representing a monetary value, at least one processor, and at least one memory, the memory storing machine readable code which when executed, cause the gaming machine to be configured to:
receive an ante wager from a player via one of the input devices;
dealing three cards to the player and dealing three cards to a dealer by the at least one processor and displaying at least the three player cards on the display of the gaming machine;
receiving an input from the player via one of the input devices to designate a two card hand using cards from the three cards dealt to the player, and the dealer forming a two card hand using the three cards dealt to the dealer;
receive an optional call wager from the player via one of the input devices;
determine via the at least one processor whether the dealer's two card hand is a qualified hand according to a predetermined qualification ranking;
when no call wager is received from the player, end the game with the player folding and forfeiting the ante wager;
when the call wager is received from the player and the dealer's two card hand is not a qualified hand,
display the call wager a push and return the call wager to the player,
display the dealer's two card hand, compare via the at least one processor the player's two card hand to the dealer's two card hand, pay out the ante wager when the player's two card hand outranks the dealer's two card hand via one of the output devices, and retain the ante wager when the dealer's two card hand outranks the player's two card hand; and
when the call wager is received from the player and the dealer's two card hand is a qualified hand, display the dealer's two card hand, compare via the at least one processor the player's two card hand to the dealer's two card hand, pay out the ante wager and the call wager when the player's two card hand outranks the dealer's two card hand via one of the output devices, and retain the ante wager and the call wager when the dealer's two card hand outranks the player's two card hand.

10. The gaming machine according to claim 9, wherein before dealing the three player cards and the three dealer cards, receiving an optional bonus wager from the player via one of the input devices, the optional bonus wager being based on the player's two card poker hand being a winning two card poker hand according to a predetermined pay table.

11. The gaming machine according to claim 10, wherein the predetermined pay table pays out
20 to 1 for a pair of red Aces,
15 to 1 for a pair of black Aces,
10 to 1 for a pair of Aces,
5 to 1 for a pair of Kings,
4 to 1 for a pair of Queens,
3 to 1 for a pair of Jacks,
1 to 1 for a pair of Sixes through Tens, and
a push for a pair of Twos through Fives.

12. The gaming machine according to claim 10, wherein the player may only win the optional bonus wager if the player also wins the call wager.

13. The gaming machine according to claim 9, wherein
two card poker hands are ranked in the following order from highest to lowest:
pairs with a pair of Aces being highest,
straight flushes with an Ace King straight flush being highest,
flushes with an Ace-Queen flush being highest, and
high card, with an Ace being highest; and
a two card hand with a straight with no flush has no value in rank.

14. The gaming machine according to claim 9, wherein the ante wager and the call wager are paid at 1:1 odds.

15. The gaming machine according to claim 9, further comprising:
before dealing the three player cards and the three dealer cards, receiving an optional four card bonus wager from the player, the optional four card bonus wager being based on whether the player's two card hand and the dealer's two card hand together form a predetermined winning hand, according to a predetermined four card bonus pay table.

16. The gaming machine according to claim 15, wherein the optional four card bonus wager is paid out for at least one of the following four card hands:
four Aces,
four of a kind,
four card straight flush,
two pair,
three of a kind,
four card straight, and
four card flush.

17. A method of playing a poker type game with at least one deck of physical playing cards on a gaming table, the method comprising:
receiving a wager from a player at a wager area defined at the gaming table;
from the at least one physical deck of playing cards, dealing three cards to the player at a playing station defined on the gaming table and dealing three cards to a dealer at a playing station defined on the gaming table, the player forming a two card hand comprising two cards selected from the three cards dealt to the player, and the dealer forming a two card hand comprising two cards selected from the three cards dealt to the dealer; and
comparing the player's two card hand to the dealer's two card hand and paying out the wager when the player's two card hand satisfies a predetermined criteria as compared with the dealer's two card hand, and collecting the wager when the player's two card hand does not satisfy the predetermined criteria.
